(19) United States
(12) Patent Application Publication
(10) Pub. No.: US 2020/0040962 A1
(43) Pub. Date: Feb. 6, 2020

(54) Self-swinging device

(71) Applicant: Jen-Che HUNG, Taichung City (TW)

(72) Inventor: Jen-Che HUNG, Taichung City (TW)

(21) Appl. No.: 16/051,568

(22) Filed: Aug. 1, 2018

(51) Int. Cl. F16F 15/18; F16F 15/12

(52) U.S. Cl. CPC F16F 15/18; F16F 15/1205

(57) ABSTRACT

A self-swinging device contains: a base, a support rack, two connection racks, two magnetic tools, and two insulation members. Each magnetic tool includes a case having a receiving orifice, two separation elements, two fixing points, a magnet, and two notches. Each rotary disk includes an arcuate trench proximate to a fixer, a locking projection, a drive gear, a recess, and a resilient element. A sector gear meshes with the drive gear and includes two posts. An isolative swing rod includes two metal elements, a first central shaft, two first pull columns, two first slots, a second central shaft, a second pull column, two springs, two second slots, and two third central shafts. The case includes and a retainer and the fixer which has a limitation pillar extending downward therefrom so as to retain with the arcuate trench of each rotary disk.

### FIELD OF THE INVENTION

The present invention relates to a self-swinging device which swings automatically.

### BACKGROUND OF THE INVENTION

At present, natural environment is broken overly because of development and consumption of energy, so developing repeated spontaneous power is required.

The present invention has arisen to mitigate and/or obviate the afore-described disadvantages.

### SUMMARY OF THE INVENTION

The primary aspect of the present invention is to provide a self-swinging device which magnetically attracts two magnetic tools of an isolative swing rod on the support rack and between the two magnetic tools repeatedly, and the isolative swing rod is pushed to actuate the self-swinging device to swing automatically.

Another aspect of the present invention is to provide a self-swinging device which is applicable for fans as the self-swinging device operates.

### BRIEF DESCRIPTION OF THE DRAWINGS

FIG. 1 is a schematic view showing the assembly of a self-swinging device according to a preferred embodiment of the present invention.

FIG. 2 is a schematic view showing the assembly of a part of the self-swinging device according to the preferred embodiment of the present invention.

FIG. 3 is another schematic view showing the assembly of a part of the self-swinging device according to the preferred embodiment of the present invention.

FIG. 4 is also another schematic view showing the assembly of a part of the self-swinging device according to the preferred embodiment of the present invention.

FIG. 5 is still another schematic view showing the assembly of a part of the self-swinging device according to the preferred embodiment of the present invention.

FIG. 6 is another schematic view showing the assembly of a part of the self-swinging device according to the preferred embodiment of the present invention.

FIG. 7 is also another schematic view showing the assembly of a part of the self-swinging device according to the preferred embodiment of the present invention.

FIG. 8 is a schematic view showing the operation of a part of the self-swinging device according to the preferred embodiment of the present invention.

FIG. 9 is another schematic view showing the operation of a part of the self-swinging device according to the preferred embodiment of the present invention.

FIG. 10 is a schematic view showing the operation of the self-swinging device according to the preferred embodiment of the present invention.

FIG. 11 is another schematic view showing the operation of the self-swinging device according to the preferred embodiment of the present invention.

FIG. 12 is also another schematic view showing the operation of the self-swinging device according to the preferred embodiment of the present invention.

### DETAILED DESCRIPTION OF THE PREFERRED EMBODIMENTS

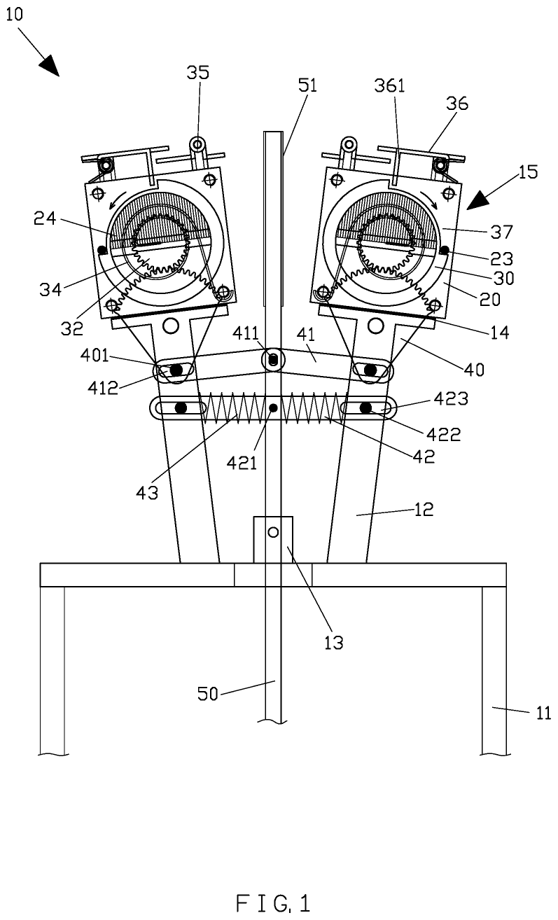

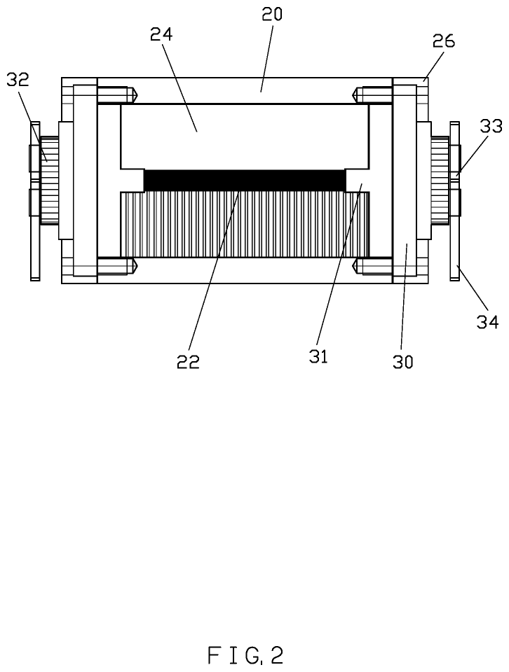

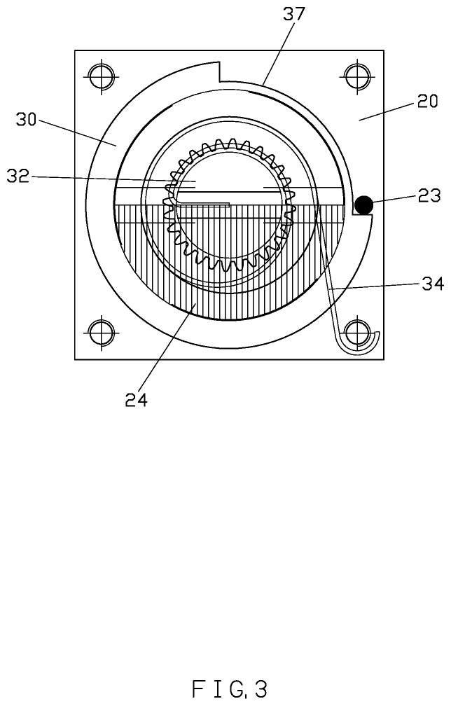

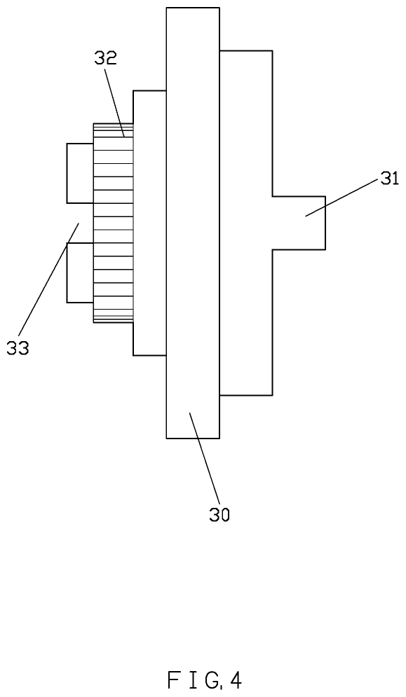

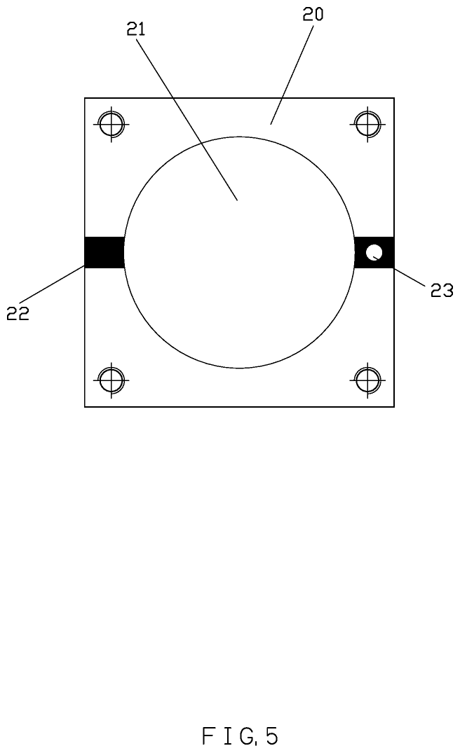

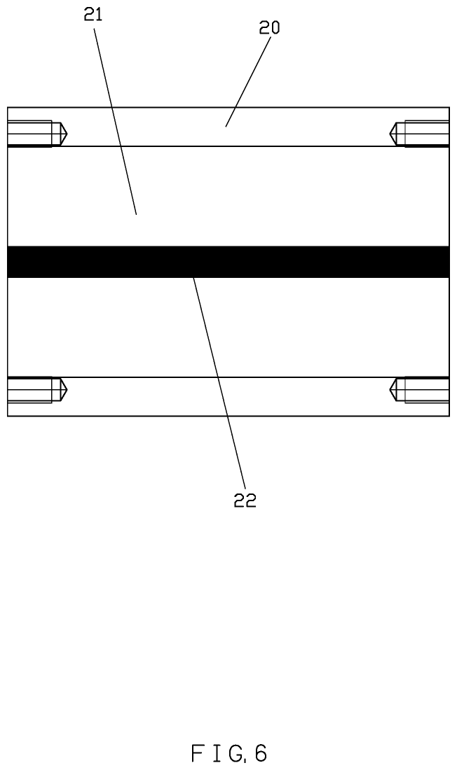

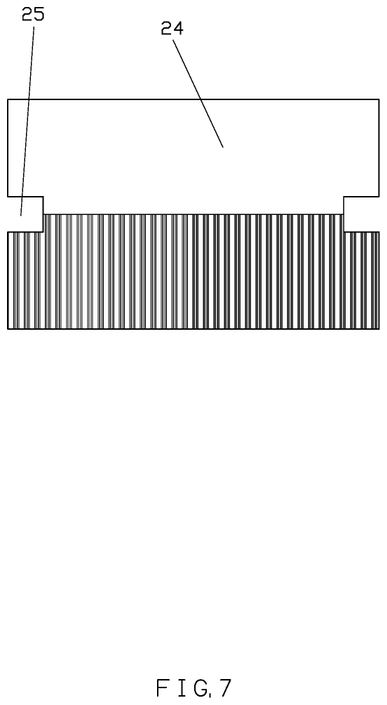

With reference to FIGS. 1-7, a self-swinging device 10 according to a preferred embodiment of the present invention comprises: a base 11, a support rack 13 mounted on a central position of the base 11, two connection racks 12 arranged beside the support rack 13 individually, two magnetic tools 15 connected on two tops of the two connection racks 12 respectively, and two insulation members 14, wherein each of the two insulation members 14 is defined between each of the two connection racks 12 and each of the two magnetic tools 15.

Each magnetic tool 15 includes a case 20, and the case 20 has a receiving orifice 21 defined on a center of the case 20, two separation elements 22 arranged on two sides of a horizontal positions of the case 20 individually, two fixing points 23 formed outside the two separation elements 22 respectively, a magnet 24 accommodated in the receiving orifice 21, and two notches 25 formed on two connection positions of positive and negative electrodes on front end rear ends of the magnet 24 individually.

Two rotary disks 30 are arranged on front and rear ends of the case 20 individually, and a lid 26 is covered on each of the two rotary disks 30, wherein each rotary disk 30 includes an arcuate trench 37 defined around ¼ circumference of each rotary disk 30 proximate to a fixer 36, a locking projection 31 fixed on an inner side of each rotary disk 30 and corresponding to each notch 25, a drive gear 32 mounted on an outer sides of each rotary disk 30, a recess 33 extending outside the drive gear 32, and a resilient element 34 housed in the recess 33, wherein a first end of the lid 26 is locked on the case 20 and a second end of the lid 26 abuts against the resilient element 34.

A sector gear 40 meshes with a lower end of the drive gear 32 and includes two posts 401 erected on the two connection racks 12 individually.

An isolative swing rod 50 is mounted on the support rack 13 and between the two magnetic tools 15, and the isolative swing rod 50 includes two metal elements 51 arranged on two sides of an upper end thereof and corresponding to the two magnetic tools 15 individually, a first central shaft 411 inserted through a middle section of the isolative swing rod 50, two first pull columns 41 extending outward from two sides of the first central shaft 411 individually, two first slots 412 defined on two outer sides of the two first pull columns 41 individually so as to accommodate the two posts 401 of the sector gear 40 respectively, a second central shaft 421 secured below the first central shaft 411, a second pull column 42 connected on the second central shaft 421, two springs 43 fitted on the two sides of the second pull column 42 respectively, two second slots 423 defined besides the two springs 43 individually, and two third central shafts 422 accommodated in the two second slots 423 respectively.

The case 20 includes and a retainer 35 and the fixer 36 which are arranged on a top thereof, and the retainer 35 is located inside the isolative swing rod 50, wherein when an inner side of the retainer 35 is pressed downward, an outer of the retainer 35 lifts upward to drive the fixer 36 to lift upward, and the fixer 36 has a limitation pillar 361 extending downward therefrom so as to retain with the arcuate trench 37 of each rotary disk 30.

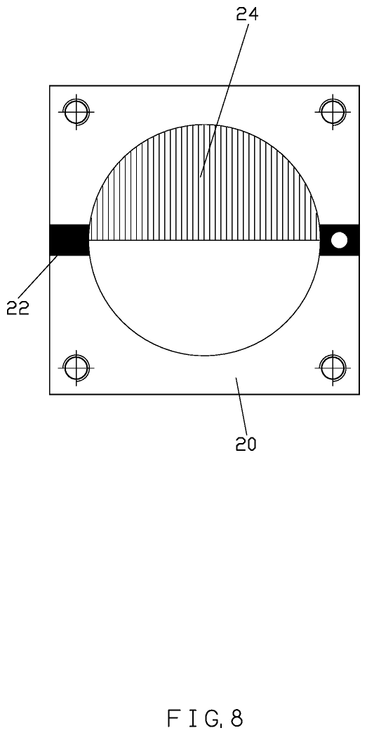

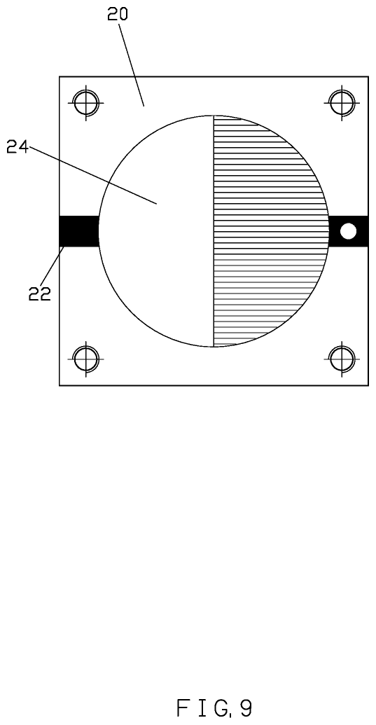

Referring to FIGS. 8 and 9, when the positive and negative electrodes of the magnet 24 are horizontal to the two separation elements 22, the two magnetic tools 15 produces magnetic effect.

When the positive and negative electrodes of the magnet 24 are perpendicular to the two separation elements 22, the two magnetic tools 15 do not produce magnetic effect.

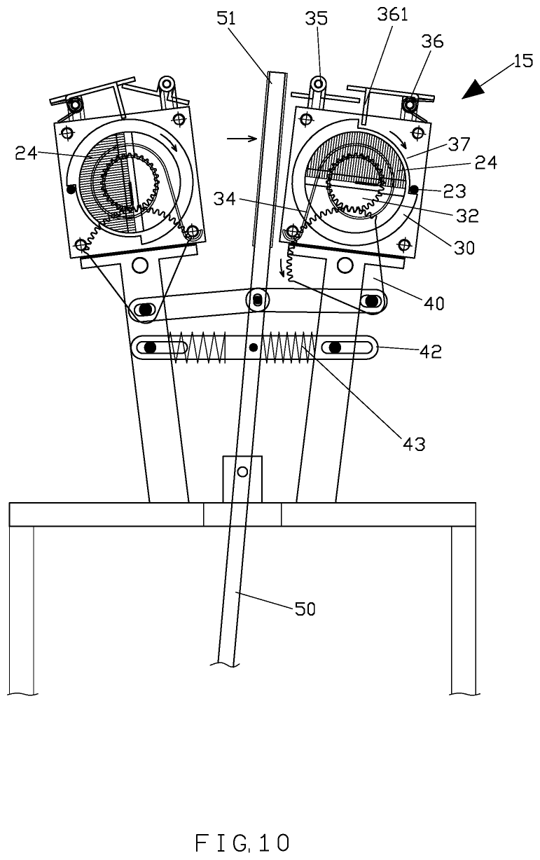

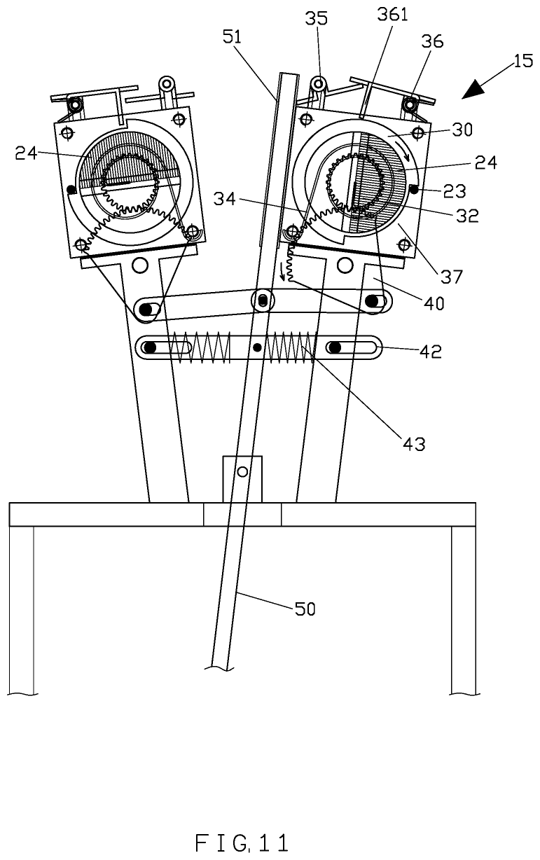

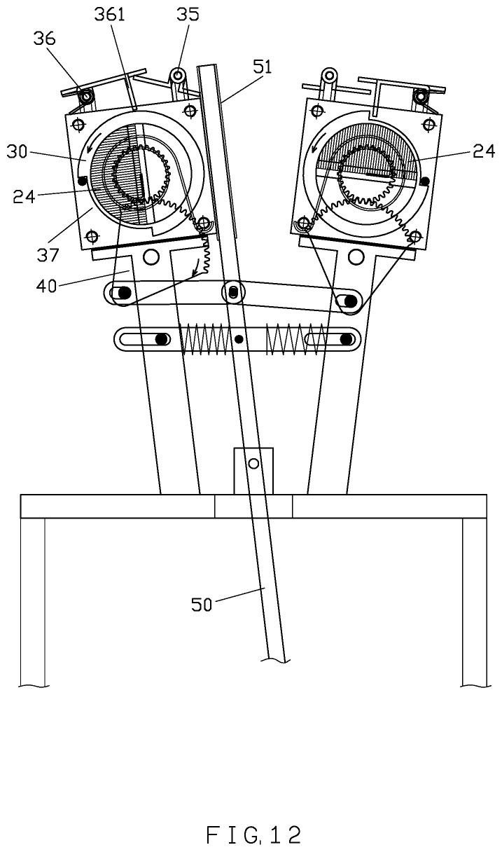

As shown in FIGS. 1 and 10-12, when the isolative swing rod 50 swings rightward, the first pull columns 41 actuates the sector gear 40 and the drive gear 32 to rotate. Since the arcuate trench 37 of the right rotary disk 30 retains with the limitation pillar 361 of the fixer 36, the right rotary disk 30 does not rotate, the right magnetic tool 15 magnetically attracts each metal element 51 of the isolative swing rod 50, and the resilient element 34 of the right rotary disk 30 is pressed by the drive gear 32. When isolative swing rod 50 abuts against the right retainer 35, the right retainer 35 drives the fixer 30 to lift upward so that the limitation pillar 361 releases the right rotary disk 30, and the right rotary disk 30 rotates until the arcuate trench 37 retains with the right fixing points 23. In the meantime, the magnet 24 of the right magnetic tool 50 does not produce the magnetic effect. The magnetic 24 of the left magnetic tool 50 produces the magnetic effect because the sector gear 40 drives the left rotary disk 30, and the left metal element 51 of the isolative swing rod 50 is magnetically attracted by the left magnetic tool 15, and the spring 43 of the right second pull column 42 is pressed to push the isolative swing rod 50 to swing leftward. When the isolative swing rod 50 swings leftward, the two magnetic tools 15 drive the two rotary disks 30 to rotate and to produce the magnetic effect repeatedly, and the isolative swing rod 50 swings automatically.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A self-swinging device comprising:
a base, a support rack mounted on a central position of the base, two connection racks arranged beside the support rack individually, two magnetic tools connected on two tops of the two connection racks respectively, and two insulation members, wherein each of the two insulation members is defined between each of the two connection racks and each of the two magnetic tools;
each magnetic tool including a case, and the case having a receiving orifice defined on a center of the case, two separation elements arranged on two sides of a horizontal positions of the case individually, two fixing points formed outside the two separation elements respectively, a magnet accommodated in the receiving orifice, and two notches formed on two connection positions of positive and negative electrodes on front end rear ends of the magnet individually;
two rotary disks arranged on front and rear ends of the case individually, and a lid covered on each of the two rotary disks, wherein each rotary disk includes an arcuate trench defined around ¼ circumference of each rotary disk proximate to a fixer, a locking projection fixed on an inner side of each rotary disk and corresponding to each notch, a drive gear mounted on an outer sides of each rotary disk, a recess extending outside the drive gear, and a resilient element housed in the recess, wherein a first end of the lid is locked on the case and a second end of the lid abuts against the resilient element;
a sector gear meshing with a lower end of the drive gear and including two posts erected on the two connection racks individually;
an isolative swing rod mounted on the support rack and between the two magnetic tools, and the isolative swing rod including two metal elements arranged on two sides of an upper end thereof and corresponding to the two magnetic tools individually, a first central shaft inserted through a middle section of the isolative swing rod, two first pull columns extending outward from two sides of the first central shaft individually, two first slots defined on two outer sides of the two first pull columns individually so as to accommodate the two posts of the sector gear respectively, a second central shaft secured below the first central shaft, a second pull column connected on the second central shaft, two springs fitted on the two sides of the second pull column respectively, two second slots defined besides the two springs individually, and two third central shafts accommodated in the two second slots respectively;
the case including and a retainer and the fixer which are arranged on a top thereof, and the retainer being located inside the isolative swing rod, wherein when an inner side of the retainer is pressed downward, an outer of the retainer lifts upward to drive the fixer to lift upward, and the fixer has a limitation pillar extending downward therefrom so as to retain with the arcuate trench of each rotary disk.
